(19) United States
(12) Patent Application Publication
(10) Pub. No.: US 2022/0056217 A1
(43) Pub. Date: Feb. 24, 2022

(54) PROCESS FOR PREPARING SPHERICAL SILICONE RESIN PARTICLES

(71) Applicant: Wacker Chemie AG, Munich (DE)

(72) Inventors: Sebastian Knör, Emmerting (DE); Sebastian Kröner, Burghausen (DE)

(73) Assignee: Wacker Chemie AG, Munich (DE)

(21) Appl. No.: 17/299,332

(22) PCT Filed: Dec. 10, 2018
(86) PCT No.: PCT/EP2018/084241

§ 371 Date: Jun. 3, 2021

(51) Int. Cl. C08G 77/18; C08G 77/06; C08G 77/36

(52) U.S. Cl. CPC C08G 77/18; C08G 77/36; C08G 77/06

(57) ABSTRACT

A process for preparing spherical silicone resin particles in which alkoxysilanes are reacted with water to form a hydrolysate is provided. The resulting silicone resin particles are isolated from a mixture. The silicone resin particles are dried and the particles are deagglomerated by ultrasonic sieving.

The invention relates to a process for preparing spherical silicone resin particles which are deagglomerated by ultrasonic sieving.

The prior art includes various processes for preparing spherical polymethylsilsesquioxane particles. JP3970449B2 describes the optimization of the space-time yield and the control of the particle size. During the drying process, the particles fuse and a network structure is built up.

Pulverulent products are obtained by laborious drying and subsequent grinding.

Crushing or grinding by means of a jet mill is necessary for the deagglomeration of the particles that fuse during conventional drying. By means of spray drying, as described in WO18065058A1, laborious grinding can be avoided, but does not result in complete deagglomeration.

The invention relates to a process for preparing spherical silicone resin particles in which alkoxysilanes are reacted with water to form a hydrolyzate,

the resulting silicone resin particles are isolated from the mixture,
the silicone resin particles are dried and
the particles are deagglomerated by ultrasonic sieving.

With ultrasonic sieving, complete deagglomeration of the spherical silicone resin particles is achieved with comparatively little effort.

Agglomeration-free spherical silicone resin particles are obtained according to the prior art by drying and subsequent grinding, or alternatively by spray drying. The process according to the invention is significantly more effective and cheaper. The particles can be dried substantially faster and cheaper in compact industrial drying systems, for example paddle dryers, than with spray drying. At the same time, the laborious grinding step, which is necessary in such drying processes according to the prior art, is avoided. The usual safeguard sieving of the product after drying, which is common in industrial powder production, is replaced by a specific ultrasonic sieving.

Ultrasonic sieving is a well-known cleaning process in order to avoid clogging and blockage of sieve meshes due to adhesion or lodged grains and thus to maintain constant flow rates and increased sieving capacities. However, it is completely surprising that the energy input of the ultrasonic sieve is sufficient to separate agglomerates present and to achieve complete deagglomeration at 99% yield. Additional technical complexity according to the prior art, such as grinding or spray drying, can thus be avoided.

In the case of ultrasonic sieving, a sieve mesh is used having a mesh size of preferably 10 to 40 μm, particularly preferably 15 to 25 μm, especially 18 to 22 μm. Virtually complete passage through the sieve can be achieved with a high specific mass throughput. It is known from laboratory sieving (RETSCH AS 200 basic sieve shaker), and sieving tests on normal vibration sieving machines without oversize grain discharge, that a good part of the particles produced according to the latest prior art are in agglomerated form and do not pass through a conventionally operated sieve mesh having a mesh size of 20 μm, but remain thereon. This is disadvantageous because the remaining oversize grain has to either be removed from the sieve as lost product or has to be deagglomerated by other further processing steps. Passing aids such as scrapers or brushes, which can be moved across the sieve mesh, lead to abrasion or hair breakage and thus to product contamination.

Ultrasonic sieving is preferably carried out using an ultrasonic probe on a sieve frame, which transmits the corresponding vibrations to the sieve mesh. The ultrasonic sieving is preferably carried out in the frequency range from 30 to 38 kHz, particularly preferably 33 to 37 kHz, especially 34.5 to 35.5 kHz. The ultrasonic sieving is preferably carried out with a vibration amplitude of 1 to 100 pm, particularly preferably 1 to 10 μm, especially 2 to 5 μm. The ultrasonic sieving is preferably carried out with an area-specific power of 10 to 500 W/m², particularly preferably 50 to 300 W/m², especially 100 to 200 W/m². Surprisingly, virtually complete deagglomeration of the particles and thus virtually complete passage through the sieve can be achieved. No coarse material is removed. There is no accumulation of coarse material on the sieve mesh; instead, agglomerates are broken up and pass completely through the sieve mesh.

Variation of frequency during operation is preferred. The particles on the sieve mesh are thrown to a height of preferably 0.3 to 10 cm, especially 0.5 to 3 cm, as a result of the ultrasound excitation.

Tapping aids are preferably used in ultrasonic sieving.

With ultrasonic sieving, specific mass throughputs of 100 to 150 kg/(h·m²) can be achieved.

Conventionally, such ultrasonic systems are used by cleaning clogged or blocked sieve meshes. This often results in higher specific mass throughputs, since a larger part of the sieve area remains usable than without ultrasonic cleaning. However, the present invention differs in this effect since a 20 μm sieve does not become blocked by the particles. The good area-specific mass throughputs are due to efficient deagglomeration of the particles.

The alkoxysilanes are selected from mono-, di-, tri- and tetraalkoxysilanes. The proportion of trialkoxysilanes is at least 40 mol %, particularly preferably at least 50 mol %, especially at least 70 mol %. The content of tetraalkoxysilanes is preferably at most 10 mol %, more preferably at most 5 mol %, especially at most 1 mol %. The content of dialkoxysilanes is preferably at most 60 mol %, more preferably at most 50 mol %, especially at most 30 mol %.

In a preferred process, polysilsesquioxane particles are prepared using trialkoxysilanes.

When the alkoxysilanes are reacted with water to form a hydrolyzate, identical or different alkoxysilanes can be used. The same or different alkoxysilanes can be added simultaneously or at any time before the particles are isolated.

The reaction of the alkoxysilanes with water to form a hydrolyzate can take place in an acidic, basic or neutral medium. Preferably, the alkoxysilanes are reacted with acidified water.

The hydrolyzate is preferably mixed with base in one or more portions. The hydrolyzate can be added to the base or the base can be added to the hydrolyzate.

Preferably at least 20% by weight, particularly preferably at least 40% by weight, especially preferably at least 70% by weight, of the alkoxysilanes are added at least 5 minutes, preferably at least 10 minutes, especially at least 15 minutes, before adding a base. As a result, silicone resin particles of different size, hardness and elasticity or with functional groups on the surface or with core-shell structure can be produced.

In a preferred method, at least 80% by weight, in particular at least 90% by weight, of the alkoxysilanes are used at least 30 minutes before addition of the base, and preferably at most 20% by weight, in particular at most 10% by weight, of the alkoxysilanes are added at least 1 hour, preferably at least 1.5 and especially at least 2 hours after adding the base.

It is particularly preferable to add the total amount of alkoxysilanes at least 30 minutes before adding the base.

The alkoxysilanes preferably bear to C₁-C₄-alkoxy radicals, preferably ethoxy radicals or especially methoxy radicals.

In addition to the alkoxy radicals, the alkoxysilanes bear hydrocarbon radicals having 1 to 16 carbon atoms or radicals R^{a} having functional groups.

The hydrocarbon radicals preferably have 1 to 4 carbon atoms, the methyl radical being particularly preferred.

Examples of radicals R^{a} having functional groups are glycol radicals and hydrocarbon radicals having functional organic groups selected from the group of the phosphoric esters, phosphonic esters, epoxy functions, amino functions, methacrylate functions, carboxyl functions, acrylate functions, olefinically or acetylenically unsaturated hydrocarbons.

The respective functional groups may optionally be substituted.

The radicals R^{a} may optionally be hydroxy-, alkyloxy- or trimethylsilyl-terminated. In the main chain, non-adjacent carbon atoms may be replaced by oxygen atoms.

The functional groups in R^{a} are usually not bonded directly to the silicon atom. An exception thereto is formed by olefinic or acetylenic groups which can also be directly bonded to silicon, in particular the vinyl group. The remaining functional groups in R^{a} are bonded to the silicon atom via spacer groups, where the spacer is always Si—C-bonded. The spacer here is a divalent hydrocarbon radical comprising 1 to 30 carbon atoms and in which non-adjacent carbon atoms may be replaced by oxygen atoms and which may also contain other heteroatoms or heteroatom groups, although this is not preferable.

The preferred functional groups, methacrylate, acrylate and epoxy, are preferably bonded to the silicon atom via a spacer, the spacer consisting of 3 to 15 carbon atoms, preferably 3 to 8 carbon atoms, especially 3 carbon atoms, and optionally also at most one to 3 oxygen atoms, preferably at most 1 oxygen atom.

The carboxyl group, which is also preferred, is preferably bonded to the silicon atom via a spacer, the spacer consisting of 3 to 30 carbon atoms, preferably 3 to 20 carbon atoms, especially 3 to 15 carbon atoms, and optionally also of heteroatoms, but preferably at most one to 3 oxygen atoms, preferably at most 1 oxygen atom, especially no oxygen atom. Radicals R^{a} bearing carboxyl radicals as functional group are described by general formula (VIII)

Y¹—COOH (VIII),

where Y¹ is preferably a divalent linear or branched hydrocarbon radical having up to 30 carbon atoms, where Y¹ may also contain olefinically unsaturated groups or heteroatoms and the atom of radical Y¹ directly bonded to the silicon is a carbon. Heteroatom-containing fragments that may typically be present in the radical Y¹ are —N(R⁵)—C(═O)—, —C—O—C—, —N(R⁵)—, —C(═O)—, —O—C(═O)—, —C—S—C—, —O—C(═O)—O—, —N(R⁵)—C(═O)—N(R⁵)—, in which asymmetrical radicals may be incorporated into the radical Y¹ in both possible directions, where R⁵ is a hydrocarbon radical or hydrogen.

If the radical according to formula (VIII) is generated, for example, by ring opening and condensation of a maleic anhydride onto a silanol function, it would be a radical of the (cis)-C═C—COOH form.

Radicals R^{a} bearing functional groups that contain heteroatoms are, for example, carboxylic ester radicals of general formula (IXa)

Y¹—C(═O)O—Y² (IXa),

where Y¹ has the definition given above or, in a further embodiment, is not present at all in the formula (IXa). The Y² radical is quite generally an organic radical. Y² may also contain further heteroatoms and organic functions, such as double bonds or oxygen atoms, although this is not preferable. Preferred as Y² are hydrocarbon radicals, such as alkyl radicals, such as the methyl, ethyl, n-propyl, isopropyl, n-butyl, isobutyl, tert-butyl, n-pentyl, isopentyl, neopentyl, tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as cyclopentyl, cyclohexyl, cycloheptyl and methylcyclohexyl radicals, aryl radicals such as the phenyl, naphthyl, anthryl and phenanthryl radicals, alkaryl radicals such as tolyl radicals, xylyl radicals and ethylphenyl radicals, and aralkyl radicals such as the benzyl radical and the β-phenylethyl radical. Particularly preferred hydrocarbon radicals Y² are the methyl, the n-propyl, isopropyl, the phenyl, the n-octyl and the isooctyl radicals.

R^{a} may also bear an inversely bonded carboxylic ester radical as functional group, i.e. be a radical of the form (IXb)

Y¹—OC(═O)Y² (IXb)

where Y¹ and Y² have the same definition as under formula (IXa).

Radicals R^{a} bearing functional groups may also be carboxylic anhydride radicals of general formula (X) or (XI)

Y¹—C—C(═O)—O—C(═O) (X),

Y¹—R¹⁴C—C(═O)—O—C(═O)R¹⁵ (XI),

where Y¹ has the definition given above and R¹⁴ and R¹⁵ are each independently a C1-C8 hydrocarbon radical which may optionally contain heteroatoms, although this is not preferred.

Further examples of radicals R^{a} bearing functional groups are phosphonic acid radicals and phosphonic ester radicals of general formula (XII)

Y¹—P (═O )(OR¹⁶)2 (XII),

where Y¹ has the definition given above, the radicals R¹⁶ are preferably each independently hydrogen or hydrocarbon radicals having up to 18 carbon atoms. Preferred phosphonic acid radicals are those in which R¹⁶ is hydrogen, methyl or ethyl, although this list should be considered to be non-limiting.

Examples of further radicals R^{a} bearing functional groups are acryloyloxy and methacryloyloxy radicals of methacrylic esters or acrylic esters such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, t-butyl acrylate, t-butyl methacrylate, 2-ethylhexyl acrylate and norbornyl acrylate. Particular preference is given to methyl acrylate, methyl methacrylate, n-butyl acrylate, isobutyl acrylate, t-butyl acrylate, 2-ethylhexyl acrylate and norbornyl acrylate.

Further examples of radicals R^{a} bearing functional groups are the preferred olefinically unsaturated hydrocarbon radicals R¹⁷ of formula (XIII) and (XIV)

Y¹—CR⁷═CR⁸R⁹ (XIII)

Y¹—C≡CR¹⁰ (XIV),

where Y¹ has the definition given above or, in a further embodiment, is not present at all in formulae (XIII) and (XIV), and the radicals R⁷, R⁸, R⁹ and R¹⁰ are each independently a hydrogen atom or a C1-C8 hydrocarbon radical which may optionally contain heteroatoms, the hydrogen atom being the most preferred radical. Particularly preferred radicals (XIII) are the vinyl radical, the propenyl radical and the butenyl radical, especially the vinyl radical. The radical (XIII) may also be a dienyl radical bonded via a spacer, such as the 1,3-butadienyl or isoprenyl radical bonded via a spacer.

Further examples of R^{a} radicals bearing functional groups are those having epoxy groups of formulae (XV) and (XVI),

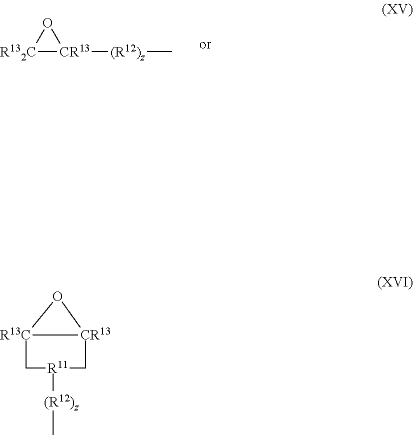

where

R¹² is a divalent hydrocarbon radical having 1 to 10 carbon atoms per radical, which may be interrupted by an ether oxygen atom,

R¹³ is a hydrogen atom or a monovalent hydrocarbon radical having 1 to 10 carbon atoms per radical, which may be interrupted by an ether oxygen atom,

R¹¹ is a trivalent hydrocarbon radical having 3 to 12 carbon atoms per radical and z is 0 or 1.

Suitable examples of such epoxy-functional radicals R^{a} are
3-glycidoxypropyl,
3,4-epoxycyclohexylethyl,
2-(3,4-epoxy-4-methylcyclohexyl)-2-methylethyl,
3,4-epoxybutyl,
5,6-epoxyhexyl,
7,8-epoxydecyl,
11,12-epoxydodecyl and
13,14-epoxytetradecyl radicals.

Preferred epoxy radicals R^{a} are the 3-glycidoxypropyl radical and the 3,4-epoxycyclohexylethyl radical.

Further examples of R^{a} radicals bearing functional groups are those having amino groups of general formula (XVIII)

—R²⁰—[NR²¹—R²²—]ₙNR²¹₂ (XVIII),

where R²⁰ is a divalent linear or branched hydrocarbon radical having 3 to 18 carbon atoms, preferably an alkylene radical having 3 to 10 carbon atoms,

R²¹ is a hydrogen atom, an alkyl radical having 1 to 8 carbon atoms or an acyl radical, such as acetyl radical, preferably a hydrogen atom,

R²² is a divalent hydrocarbon radical having 1 to 6 carbon atoms, preferably an alkylene radical having 1 to 6 carbon atoms,

n is 0, 1, 2, 3 or 4, preferably 0 or 1.

Preference is given to a process for preparing spherical polysilsesquioxane particles, in which in a first step trialkoxysilanes of general formula (I)

RSi(OR¹)₃ (I),

in which
R is a hydrocarbon radical having 1 to 16 carbon atoms, the carbon chain of which may be interrupted by non-adjacent —O— groups,
R¹ is a to C₁- to C₄-alkyl radical,
   are reacted with acidified water with a pH of at most 6 with mixing to form a hydrolyzate,
   in a second step the hydrolyzate is mixed with a solution of a base in water or C₁- to C₄-alkanol,
   in a third step the mixture is kept for at least 2 hours,
   in a fourth step the polysilsesquioxane particles are isolated from the mixture,
   in a fifth step the polysilsesquioxane particles are dried and
   in a sixth step the particles are deagglomerated by ultrasonic sieving.

R is preferably an alkyl radical having 1 to 6 carbon atoms or a phenyl radical, especially an ethyl, vinyl or methyl radical.

R¹ is preferably a methyl, ethyl or n-propyl radical, especially a methyl radical.

Preferred trialkoxysilanes of general formula (I) are methyltrimethoxysilane, methyltriethoxysilane, methyltri-n-propoxysilane, methyltriisopropoxysilane and methyltris(2-methoxyethoxy)silane and mixtures thereof.

The conversion to a hydrolyzate is preferably carried out in acidified water with a pH of at most 5.5, particularly preferably at most 4.5 and preferably at least 1, particularly preferably at least 2, especially at least 2.3.

The water used is preferably desalinated and, prior to acidification, preferably has a conductivity of at most 50 μS/cm, preferably at most 30 μS/cm, particularly preferably at most 20 μS/cm, especially preferably at most 10 μS/cm, measured in each case at 20° C.

Bronsted acids or Lewis acids can be used to acidify the water used. Examples of Lewis acids are BF₃, AlCl₃, TiCl₃, SnCl₄, SO₃, PCl₅, POCl₃, FeCl₃ and hydrates thereof and ZnCl₂. Examples of Bronsted acids are hydrochloric acid, hydrobromic acid, sulfuric acid, nitric acid, nitrous acid, chlorosulfonic acid, phosphoric acids such as ortho-, meta- and polyphosphoric acids, boric acid, selenious acid, nitric acid, carboxylic acids such as formic acid, acetic acid, propionic acid, citric acid and oxalic acid, haloacetic acids such as trichloroacetic and trifluoroacetic acid, p-toluenesulfonic acid, acidic ion exchangers, acidic zeolites and acid-activated bleaching earth.

Preference is given to hydrochloric acid, hydrobromic acid and acetic acid.

The more precisely the target pH is set, the lower the scatter in the mean particle size between different reaction batches. The variance in the pH is preferably less than ±1, preferably less than ±0.5, particularly preferably less than ±0.3, especially less than ±0.1.

Kinetic studies by means of NMR have shown that the rate of hydrolysis of the trialkoxysilanes of general formula (I) in an acidic medium depends on the pH and proceeds more rapidly with decreasing pH. The rate of the condensation reaction is also pH-dependent and increases at low pH.

The acidification of the water can be carried out prior to the reaction to form the hydrolyzate, at the same time as the reaction or both prior to the reaction and at the same time as the reaction.

The hydrolysis of the trialkoxysilane of general formula (I) is a weakly exothermic reaction. In a preferred embodiment, the temperature in the first step is maintained, optionally by heating or cooling, preferably at 0° C. to 80° C., preferably at 10° C. to 50° C., particularly preferably at 15° C. to 40° C., very particularly preferably at 15 to 30° C., especially at 15-25° C., where the temperature fluctuation after reaching the target temperature is preferably less than 10° C., more preferably less than 5° C. The metered addition of the trialkoxysilane can be started before or after reaching the target temperature.

In another embodiment, the trialkoxysilane is added in one portion. In this case, the heat is not actively, or only partially, dissipated. In this embodiment, there is an exothermic increase in temperature after addition of the trialkoxysilane. The temperature of the reaction in the first step is 20° C. to 80° C., preferably to 60° C.

The trialkoxysilane is metered in over 0.5 to 5 h, particularly preferably at most 2 h. There is a smooth transition between the embodiments of rapid addition and metered addition, i.e. addition is possible quickly over 15 minutes with partial removal of heat up to a maximum of 40° C., or metered addition is possible, for example, over 2 h, but in this case only with slight cooling, initially allowing the temperature to rise to 30° C. and holding it at this temperature.

Particular preference is given to metered addition at a constant temperature.

In the first step, 5 to 43 parts by weight, preferably 11 to 34 parts by weight, especially 13 to 25 parts by weight, of trialkoxysilane are preferably used per 100 parts by weight of water.

Mixing in the first step can be carried out by means of a static mixer or preferably by means of a stirrer.

Preferably, in a step 1a following step 1, the pH of the hydrolyzate is adjusted to a value of 1 to 6. Preferably, in step 1a for adjusting the pH of the hydrolyzate, an acid is used which can also be used in the first step, or a base is used which can also be used in the second step.

Preferably, after metered addition of the trialkoxysilane and optionally adjusting the pH in step 1a, the mixture is stirred for a further 5 min to 5 h, particularly preferably 10 min to 3 h, especially 15 min to 1.5 h. The further stirring time is preferably selected so that the sum of the time taken to add the silane and the further stirring time do not exceed 6 hours.

The temperature during further stirring is maintained at 0° C. to 60° C., preferably at 10° C. to 50° C., particularly preferably at 10° C. to 40° C., very particularly preferably at 10 to 30° C., especially at 15 to 25° C. The difference between the reaction temperature in the first step and the temperature during further stirring is preferably less than 20° C., preferably less than 10° C., especially less than 5° C.

In the second step, the base is preferably selected from alkali metal hydroxide, alkaline earth metal hydroxide, alkali metal methoxide, ammonia and organic amines. Preferred organic amines are alkylamines such as mono-, di- or triethylamine, mono-, di- or trimethylamine or 1,2-ethylenediamine. Preference is given to using the hydroxides of Li, Na, K.

A solution of alkali metal hydroxide in water or in an alkanol having 1 to 3 carbon atoms is preferably used in the second step. Preferred alkanols are 1-propanol, 2-propanol, ethanol and especially methanol. A solution of alkali metal hydroxide in water is also preferred. Suitable solutions are dilute or concentrated solutions of alkali metal hydroxide from 0.001 to 1100 g/l at 20° C., preferably from 0.01 to 500 g/l, particularly preferably from 0.1 to 500 g/l.

The pH of the hydrolyzate in the second step is preferably adjusted at the temperature of the hydrolyzate after the first step.

The pH of the hydrolyzate in the second step is preferably adjusted with mixing. Mixing may be carried out by means of a static mixer or, preferably, by means of a stirrer.

When using a solution of alkali metal hydroxide in an alkanol having 1 to 3 carbon atoms, the particles adhere to one another particularly weakly, show a particularly lower degree of agglomeration and have less of a tendency to clump. The particles exhibit a drier skinfeel which is preferred in cosmetic applications. KOH is preferred as alkali metal hydroxide.

As an alternative to NaOH and KOH, it is also possible to use an NaOH or KOH former, which in the second step reacts immediately with the water present in the hydrolyzate to form NaOH or KOH. Examples of these are sodium ethoxide, potassium methoxide, NaH and KH. In this embodiment, preference is given to using sodium ethoxide or potassium methoxide in methanolic solution.

Preferably, sufficient base solution is added that a pH of at least 6, preferably at least 6.5 and at most 10, preferably at most 9.5 is reached, measured in each case directly after addition of the base. By the addition of the amount of base, the particle size can be influenced, with low pH producing larger particles. The particularly preferred pH is 7.5 to 9.

The solution of base is preferably added within 10 seconds to 10 minutes, in particular within 1 to 3 minutes, preferably with vigorous and brief stirring.

In a preferred embodiment, the temperature of the addition of base in the second step is preferably maintained at 0° C. to 60° C., preferably at 10° C. to 50° C., particularly preferably 10° C. to 40° C., very particularly preferably at 10° C. to 30° C., especially at 15° C. to 25° C. The difference between the temperature during further stirring and the temperature for adding the base is preferably less than 20° C., preferably less than 10° C., especially less than 5° C.

Fluid behavior, that is to say liquid-like behavior, is particularly evident immediately after the polysilsesquioxane particles have been shaken up. The greater the increase in volume, the more pronounced the fluid behavior. A material that has a 50% increase in volume already shows fluid behavior, which is expressed, for example, in that the material in the container—immediately after shaking—flows back and forth like a liquid when the container is tilted. A material with a 50% increase in volume sediments very rapidly and reverts to its non-fluid original state, which is disadvantageous. The spherical polysilsesquioxane particles preferably exhibit an increase in volume of at least 100%.

The mixing in the second step can be carried out by means of a static mixer or, preferably, by means of a stirrer.

After the second step, the mixing is preferably discontinued within 10 minutes, preferably within 5 minutes. After the second step, the mixture is preferably not agitated for at least 1 h, preferably at least 1.5 h, particularly preferably at least 2.5 h. A stirrer can then be switched on at low speed to prevent the particles from sedimenting. This is optional and not necessary, since the sedimented polysilsesquioxane particles can be easily stirred up.

After the second step, the temperature of the mixture is preferably altered by no more than 20° C., preferably no more than 10° C., for at least 1 h, preferably at least 1.5 h, particularly preferably at least 2.5 h.

On agitation in the initial phase in the third step, in which the particles are formed, there is an increased incidence of deformed, fused or agglomerated particles.

In a preferred embodiment, the mixture is not agitated in the third step until the polysilsesquioxane particles are isolated.

Preferably, the mixture is kept in the third step for at least 4 h, particularly preferably at least 7 h, especially at least 10 h, before the polysilsesquioxane particles are isolated. Storage times of up to 12 weeks are also possible.

Cloudiness can usually already be seen after 1-30 minutes.

The temperature in the third step is preferably 0° C. to 60° C., more preferably 10° C. to 50° C., particularly preferably 10° C. to 40° C., very particularly preferably 10° C. to 30° C., especially 15° C. to 25° C. Larger particles form at low temperatures and smaller particles form at higher temperatures.

At a temperature of 15° C. to 25° C., there is little or no temperature gradient between the reaction mixture and the outside, resulting in a minimal thermal gradient between the reactor wall and the reaction solution and hence minimized thermal convection during precipitation of the particles.

The process according to the invention can be carried out as a batchwise process, as a semi-batchwise process and/or as a continuous process.

In a preferred embodiment, the mixture is neutralized after the third step by adding an acid.

The resulting silicone resin particles are isolated from the mixture in the fourth step in the preferred process, preferably by filtration or centrifugation.

After isolation, the particles are preferably washed with demineralized water or alcohol.

The isolated silicone resin particles are dried in the fifth step in the preferred process. The particles are preferably dried at 40 to 250° C., particularly preferably at 100 to 240° C., especially preferably at 140 to 220° C. The drying can take place at ambient pressure or under reduced pressure. During drying, there is also condensation of free Si—OH groups, which, according to kinetic measurements, preferably proceeds from 150° C., better from 180° C., ideally from 200° C. Particles which are dried for a long time at 100° C. are dry, but have a high Si—OH content. At 150° C., the Si—OH content is significantly reduced but not yet completely removed; at 200° C., Si—OH groups are significantly reduced again. A reduced Si—OH content results in advantages in terms of distribution behavior and fluidization of the particles.

Examples of suitable dryers are paddle dryers, fluidized bed dryers, tray dryers, flow dryers or drum dryers.

The particles are preferably dried for 0.5 to 100 h, particularly preferably 0.5 to 24 h, especially 1 to 14 h.

The dried unsieved silicone resin particles, especially polysilsesquioxane particles, preferably have at least 30% by weight, more preferably at least 40% by weight, particularly preferably at least 50% by weight, of a sieve fraction <20 μm.

The dried unsieved silicone resin particles, especially polysilsesquioxane particles, preferably have at least 60% by weight, more preferably at least 70% by weight, of a sieve fraction <40 μm.

The dried unsieved silicone resin particles, especially polysilsesquioxane particles, preferably have less than 25% by weight, more preferably less than 20% by weight, particularly preferably less than 15% by weight, of a sieve fraction >100 μm.

The particularly high freedom from agglomeration of the silicone resin particles, especially polysilsesquioxane particles, is achieved by the ultrasonic sieving described above.

The silicone resin particles, especially polysilsesquioxane particles, preferably have a spherical shape when examined under an electron microscope.

The spherical silicone resin particles, especially polysilsesquioxane particles, preferably have an average sphericity y of at least 0.6, in particular at least 0.7. The spherical polysilsesquioxane particles preferably have an average roundness x of at least 0.6, in particular at least 0.7. The roundness x and sphericity y can be determined according to DIN EN ISO 13503-2, page 37, Annex B.3, in particular Figure B.1.

All process steps are preferably carried out at the pressure of the ambient atmosphere, i.e. about 0.1 MPa (abs.); they can also be carried out at higher or lower pressures. Preference is given to pressures of at least 0.08 MPa (abs.) and particularly preferably at least 0.09 MPa (abs.), particularly preferably at most 0.2 MPa (abs.), in particular at most 0.15 MPa (abs.).

The meanings of all aforementioned symbols in the aforementioned formulae are each independent of one another. The silicon atom is tetravalent in all formulae.

In the following examples, unless otherwise stated in each case, all amounts and percentages are based on weight, all pressures are 0.10 MPa (abs.) and all temperatures are 20° C.

### Sieve Analysis:

The sieve analysis is carried out by means of dry sieving on a Retsch AS 200 basic analytical sieve machine at 100% amplitude. For the analysis, four sieves according to DIN ISO 3310 having the following mesh sizes are stacked: 200 μm, 100 μm, 40 μm, 20 μm, bottom. In each case 50 g of substance are applied to the uppermost sieve (200 μm) and sieved for 10 minutes.

### Volume-Weighted Particle Size Distribution d₅₀

The volume-weighted particle size distribution is determined in accordance with ISO 13320 by means of static laser scattering using a Sympatec HELOS device with RODOS dry disperser with 2 bar compressed air as dispersing medium. The d₅₀ indicates the median particle size.

### Measurement of the pH:

An electrical pH meter with a glass electrode is immersed in the reaction mixture.

### EXAMPLES

### General Procedure 1: Preparation of Polymethylsilsesquioxane Particles

An initial charge of 32 kg of demineralized water having a conductivity of 0.1 μS/cm in a glass-lined 50 liter stirred tank with jacket cooling is kept at a controlled temperature of 20° C. The contents are stirred at 150 rpm. The pH is adjusted to 4.40 by adding 0.1 molar hydrochloric acid. 7.0 kg of methyltrimethoxysilane are metered in over 1 hour, the temperature being kept at 20° C. On completion of the metered addition, the mixture is stirred at 20° C. for 30 minutes. (Step 1)

The pH is corrected (step 1a).

After the correction is complete, the mixture is stirred at 20° C. for a further 30 minutes. 363 g of 0.5 molar methanolic KOH solution are added within 1 min at 20° C. and the mixture is mixed homogeneously for a total of 3 min (step 2). The stirrer is then switched off. After 21 hours (step 3), the precipitated particles are filtered off, washed with demineralized water and dried at 150° C. for 18 h.

### Example 1

Polymethylsilsesquioxane particles were prepared according to general procedure 1. In step 1a the pH was corrected to 2.8. The particles obtained have a median particle size d50 of 5.0 μm.

### Example 2

The deagglomerating sieving of the particles from example 1 was carried out using a VRS 600 vibrating round sieving machine with ultrasonic excitation of the sieve mesh at 35 kHz (mesh size 20 μm, sieve diameter 600 mm) from Allgaier, available from Allgaier Process Technology GmbH, Ulmer Strasse 75, 73066 Uhingen, Germany, using abrasion-resistant hollow cylinder tapping aids. The coarse material outlet was removed in order to avoid losses when feeding the product via the outlet. 17 kg of the particles from Example 1 were continuously applied to the sieve so that the sieve always remained covered with raw material. The particles on the sieve mesh were thrown to a height of ca. 1-2 cm. The mean mass throughput was ca. 60 kg/h, corresponding to ca. 0.21 kg/h per cm² of sieve area. There was no visible accumulation of coarse material on the sieve. Complete material throughput and thus a 100% fine fraction <20 μm were thus achieved.

### Comparative Example C1

The particles from Example 1 were sieved using a conventional Retsch AS 200 basic throwing sieve machine from Retsch, available from RETSCH GmbH, Retsch-Allee 1-5, 42781 Haan, Germany, without a coarse material outlet, over a sieve with a mesh size of 20 μm and sieve diameter of 200 mm. 100 g of the particles from Example 1 were applied and sieved at an amplitude of 100% (corresponding to deflection ca. 2 mm) without additional tapping aid. After 10 minutes, 44 g of particles have passed the sieve, corresponding to an average mass throughput of ca. 0.009 kg/h per cm² of sieve area. The sieve shaker gives only 44% fines <20 μm. No separation of the agglomerated particles can be achieved.

### Comparative example C2

The particles from example 1 were sieved as described in comparative example C1, but with the use of an abrasion-resistant hollow cylinder tapping aid. After 10 minutes, 52 g of particles have passed the sieve, corresponding to an average mass throughput of ca. 0.01 kg/h per cm² of sieve area. Even with a tapping aid, the sieve shaker only gives 52% fines <20 μm. Only a slight separation of the agglomerated particles can be achieved.

1-11 (canceled)

12. A process for preparing spherical silicone resin particles, in which alkoxysilanes are
reacted with water to form a hydrolyzate,
the resulting silicone resin particles are isolated from a mixture,
the silicone resin particles are dried and
the particles are deagglomerated by ultrasonic sieving.

13. The process as claimed in claim 12, wherein a sieve mesh having a mesh size of 10 to 40 μm is used for the ultrasonic sieving.

14. The process as claimed in claim 12, in which the ultrasonic sieving is carried out in a frequency range from 30 to 38 kHz.

15. The process as claimed in claim 12, in which in the ultrasonic sieving, the particles on the sieve mesh are thrown to a height of 0.3 to 10 cm as a result of the ultrasound excitation.

16. The process as claimed in claim 12, in which the ultrasonic sieving is carried out at an area-specific power of 10 to 500 W/m².

17. The process as claimed in claim 12, in which the particles are isolated by filtration or centrifugation.

18. A process for preparing spherical polysilsesquioxane particles as claimed in claim 12, in which in a first step trialkoxysilanes of general formula (I)
RSi(OR¹)3 (I),
in which
R is a hydrocarbon radical having 1 to 16 carbon atoms, the carbon chain of which may be interrupted by non-adjacent —O— groups,
R¹ is a C₁- to C4-alkyl radical,
are reacted with acidified water with a pH of at most 6 with mixing to form a hydrolyzate,
in a second step the hydrolyzate is mixed with a solution of a base in water or C₁- to C4-alkanol,
in a third step the mixture is kept for at least 2 hours,
in a fourth step the polysilsesquioxane particles are isolated from the mixture,
in a fifth step the polysilsesquioxane particles are dried and
in a sixth step the particles are deagglomerated by ultrasonic sieving.

19. The process as claimed in claim 18, in which R is an ethyl radical or methyl radical.

20. The process as claimed in claim 18, in which R¹ is an ethyl radical or methyl radical.

21. The process as claimed in claim 18, in which in the first step the reaction to form the hydrolyzate is carried out at a pH of 4.5 to 2.

22. The process as claimed in claim 18, in which in the second step a solution of alkali metal hydroxide in water or in an alkanol having 1 to 3 carbon atoms is used.
